(19) United States
(12) Patent Application Publication
(10) Pub. No.: US 2020/0054175 A1
(43) Pub. Date: Feb. 20, 2020

(54) RESTAURANT FOOD ASSEMBLER ROBOT WITH SEQUENCE AND INGREDIENT MATRIX OPTIMIZATION TO INCREASE THRUPUT WITH DYNAMIC BATCH SIZE OF ORDERS PLATED

(71) Applicant: SHAMBHU NATH ROY, ROSEVILLE, CA (US)

(72) Inventors: SHAMBHU NATH ROY, ROSEVILLE, CA (US); MANISH PATEL, EL DORADO HILLS, CA (US); JOSEPH FELIPE, ROSEVILLE, CA (US)

(21) Appl. No.: 16/103,878

(22) Filed: Aug. 14, 2018

(51) Int. Cl. A47J 44/00; B25J 11/00

(52) U.S. Cl. CPC A47J 44/00; B25J 11/0045

(57) ABSTRACT

A food assembler device that works on sandwich prep table to assemble custom orders in a restaurant utilizing a robot and various attachment tools to collect ingredients from hot and cold containers based on online or manually input orders via a graphic user interface. The food assembler device does not contact any food ingredients and needs minimal cleaning. The food assembler device can be assembled with plurality of robots working together on larger food prep tables and placed along an assembly line using means to increase thruput by coordination of ordering systems, on board computers, controllers, smart weight measuring smart boats, conveyors with sequence and ingredient matrix optimization with dynamic batch size of orders.

### BACKGROUND OF THE INVENTION

The present invention generally relates to using devices to service restaurant customers with consistent quality of meal orders served according to preset menu with specified ingredients and predetermined quantities on daily basis eliminating contamination by reduced human handling.

A need exists for automated food making apparatus as disclosed in U.S. Pat. Appl. 20170172351 by Kathirasen et. al. Such apparatus based on food canisters dispensing ingredients stored in multiple canisters need extensive periodic cleaning and maintenance as they come in contact with the food stored inside them. Specifically wet ingredients can cause growth of microbes in the canisters and the dispensing mechanisms that can cause human illness caused from contaminated food as being reported frequently from popular restaurant chains. Further loading canisters with multiple ingredients requiring in upwards of dozens of canisters can be very time consuming for operators or restaurant employees negating the economic benefits of using such devices.

A need exists for On-Demand Robotic Food Assembly as disclosed in US. Pat. Appl. 20170290345 which discloses a food assembly line including conveyors and robots operable to assemble food items in response to received orders for food items. However, the food assembly line is comprised of several devices each with a unique and very specific role such as dispensing sauce on dough or spreading the sauce or dispensing carousals tailored towards multiple other ingredients. Such an assembly line as disclosed is suitable only for a large scale restaurant operation spread over a large area and not capable of assembling a single order such as salad bowl or a filling a taco shell for a single customer in a real time service environment while the customer waits.

A need therefore exists for a food assembler device which does not come in contact with any food ingredients it is assembling to eliminate need for frequent cleaning and prevent spread of food borne diseases. Further, such a device needs to be able to work with existing storage containers for all kinds of ingredients such as refrigerated, heated, dry, wet, sauces, cheeses and likes that have been used in the restaurant industry for decades and are easy to clean with very short loading times. Further the device needs to be able to adapt quickly to handle any of number of ingredients while assembling food items.

### BRIEF SUMMARY OF THE INVENTION

The present invention provides a food assembler device that can assemble ingredient items based on an order from restaurant customers without the device touching any of the food items directly and using attachment tools to pick and plate various ingredients into a destination source such as a bowl for a salad order, on a piece of bread for a sandwich, a tortilla for a burrito or a taco shell for a taco and such. The attachment tools interface with the food assembler device and prevent any contamination between the device and within individual ingredients it picks from containers in storage array know as sandwich prep table in the restaurant industry. The attachment tools are easily removable for cleaning and maintenance.

An object of the invention is to provide a versatile food assembly robot that can be placed as retrofit additions to existing restaurants that use sandwich prep tables for serving hot and cold food items. This allows to keep the existing flow of food and customers and associated business processes, health certifications while increasing business efficiencies and customer satisfaction.

A further object of the invention is the capability to take the food assembly device offline if needed and continue manual operations without significant hinderance due to the retrofitted addition of the food assembly device. An object of the invention is to make it safe for restaurant employees and customers to be around the food assembly device moving parts and robot by adding safety barriers. Further object is to allow quick replenishment of the ingredients as they are used up while serving customer orders without compromising personnel and customer safety.

Yet another object of the invention is to incorporate various types of ingredient handling attachments that are capable of picking and plating desired quantities of ingredients of various consistencies ranging from dry to wet, freely flowing liquids sauces to high viscosity avocado pastes or ice creams, fine granular rice to chunky salsa, cheeses and leafy salads. A further object is to have the attachments made from and behave as the regular tools such as ladles, spoons, tongs used in restaurants currently.

An object of the invention is to use the food assembly device to also be able to store and use a temperature measuring device to measure the temperatures of ingredients stored in the various compartments or containers of the sandwich prep tables. Such periodic temperature measurements are used for monitoring the ingredient quality, logged into an onboard computer and can be stored for generating health inspections or uploaded to a remote server.

A further object of the invention is to provide a cleaning tool to periodically monitor and ingredient spills and cleaning such spills using a vacuum tool attachment being picked by the robot and directed by machine vision incorporated into the food assembler device or manual joystick operation by an operator.

According to an embodiment of the invention, to increase efficiency of order completion during rush hours a plurality of restaurant food assembler devices are added to a single sandwich prep table. The robots of respective food assembler devices work in tandem sharing the responsibility of plating the items in their respective operation areas.

According to another embodiment of the invention the plating of ordered restaurant orders is done on smart boats that are equipped with weight measuring devices such as load cell known in the art of measuring weights. Further the smart boats are equipped with wireless communication and power sources and are able to send the weight increases detected to the onboard computer as ingredients are added to the order. This weight increase information is used to train or calibrate the robots capability to scoop ingredients from the containers or bins on the sandwich prep tables. If a robot is scooping too much than requested as per menu, the weight information is used to optimize its scooping and plating motions until correct amounts are being served. Furthermore, the amount of ingredients being served are recorded for every meal and used for quality control for weight and calories served in each plate.

A further object of the invention is to allow a quick access door mechanism that when opened trips and interlock that stops the robot of the respective food assembler device from moving and potentially hurting a restaurant employee or customer. An employee can open the door without getting hurt by robot, change an ingredient container and closed the door allowing the robot to resume its operation with the interlock back in place. Additional safety doors are provided on the sides, back and roof to prevent any unintended interactions between robots of the food assembler device and employees or customers. Small openings are provided in these safety barriers to allow orders to pass through the food assembly devices.

A further object of the invention is to use the robots and attachment tools in the food assembly device to keep reorganizing the ingredients in the containers of the sandwich prep tables to keep them servable by moving them around for preventing sticking, temperature, texture and taste uniformity. In yet another embodiment some containers or the sandwich prep tables contain water for periodically rinsing and cleaning attachment tools using the robot to dip them into these cleaning locations.

A further object is to be have the onboard computer accept orders manually via a human machine interface such as a touch screen, GUI with mouse, keyboards, serial or other communication ports and direct the robot to assemble each ingredient at an assembly location or a smart boat. Once an order is received that calls for a set of ingredients with respective quantities, the onboard computer breaks it down into steps where each step instructs its robot to pick a tool attachment from a attachment tool rack, moves to the container on the sandwich prep table where the ingredient is located, collects an intended amount by an action of scooping, dunking, grabbing or other, moves and deposits to the destination smart boat where the order is being assembled, returns the attachment tool back to the rack and gets ready for the next instruction or ingredient. Further when all the ingredients are plated the robot moved the smart boat to the next step or into the next food assembler device.

In another embodiment when multiple orders are being assembled into multiple smart boats passing through the food assembly device, the onboard computer runs a sequence and ingredient matrix optimization by reducing the number of steps for robot to collect the attachment tools and put them back on rack by depositing any ingredients which are common to adjacent orders being assembled. As an example say successive orders are a first salad bowl with mild salsa, black beans, white rice followed by second burrito with mild salsa, yellow beans, chicken, white rice followed by a third order of salad bowl with mild salsa, chicken, white rice, the robot will assemble mild salsa to all three adjacent orders present in the flow within the food assembler device with changing the salsa scooper attachment tool, will assemble chicken without changing the chicken scooping attachment tool to the second and third order and save time by eliminating steps if the orders are assembled sequentially. Computer algorithms are used to extend such optimization based on customer order dynamic stacks with ingredients in real time. Further the ingredient bin layouts are also rearranged to improve speed for orders moving through the food assembler devices.

In yet another embodiment a plurality of smart boats is used on a conveyor belt that moves in coordination with the food assembly devices stopping to allow robots to assemble and then advancing to the next step for next ingredient or move smart boats through successive food assembler devices relieving the robots of this additional tasks of moving the smart boats with orders and improving speed of operation.

Additional features and advantages of the present invention are described in, and will be apparent from, the detailed description of the preferred embodiments and from the drawings.

### BRIEF DESCRIPTION OF THE SEVERAL VIEWS OF THE DRAWING

The following is a description, by way of example only, of different embodiments of the mechanism, its variations, derivations and reductions.

FIG. 1 shows a food assembler device next to a sandwich prep table.

FIG. 2 shows a food assembler system with a food assembler device working on a sandwich prep table.

FIG. 3 shows a food assembler device working on a sandwich prep table with side covers removed and quick access door partially opened.

FIG. 4 shows a food assembler device with quick access door fully lifted up.

FIG. 5 shows a food assembler device with quick access door fully stowed into the food assembler device for full access to the sandwich prep table containers.

FIG. 6 shows an exploded view of the food assembler device showing the tool rack with its attachment tools.

FIG. 7 shows a further exploded view of the tool attachment rack with attachment tools removed.

FIG. 8 shows additional thermometer and vacuum attachment tools.

FIG. 9 shows an order smart boat in detail.

FIG. 10 shows several food attachment tools kept at the containers of the sandwich prep table.

FIG. 11 shows a food assembly device with dual robot configuration next to a large sandwich prep table.

FIG. 12 shows a food assembler system with dual robot configuration working together on a large sandwich prep table.

FIG. 13 shows a food assembler system with smart boats moved through food assembler device using a conveyor belt.

### DETAILED DESCRIPTION OF THE INVENTION

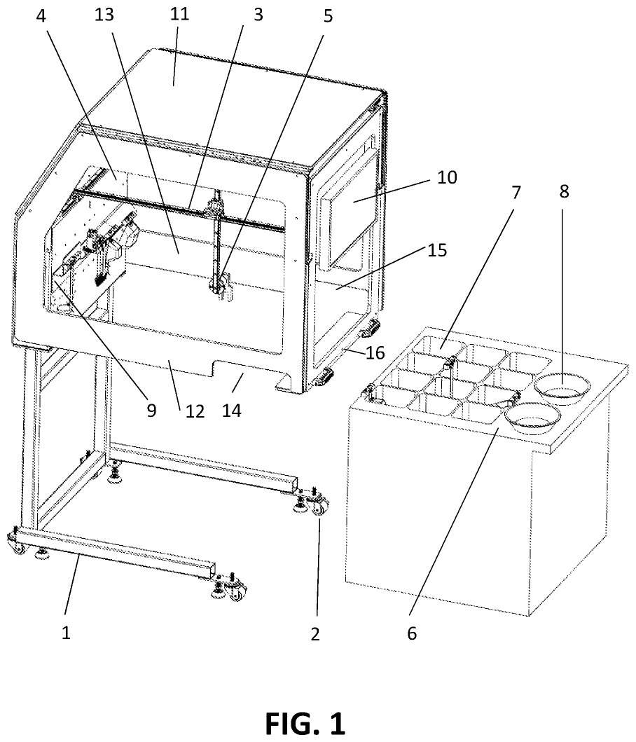

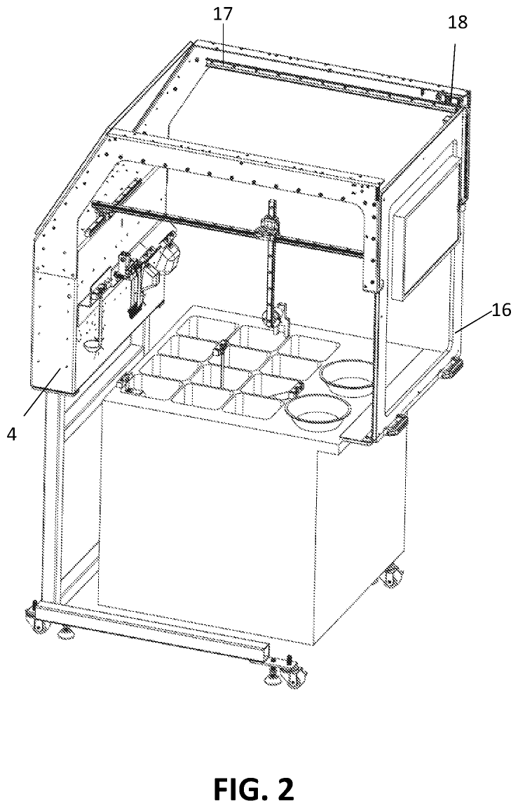

Now referring to the drawings, wherein like numerals designate like components, FIGS. 1 and 2 show a food assembler system comprising of a food assembler device 1 and a sandwich prep table 6. The food assembler device has a movable frame with castors 2 that allows it to be docked on to sandwich prep table 6 to work on assembling customer food orders into smart boats 8 with the help of a robot 3 picking ingredients from ingredient containers 7 as directed by an onboard computer 10 using an end effector 5 utilizing attachment tools available on attachment tool rack 9. Robot 5 is mounted onto a robot controller unit 4 working communicating with onboard computer 10. Top barrier 11, Side barriers 12, 13 and quick access door 16 isolate the robot 3 from employees and customers for safety. Openings 14 and 15 in the barriers allow order smart boats 8 to pass through the food assembler device’

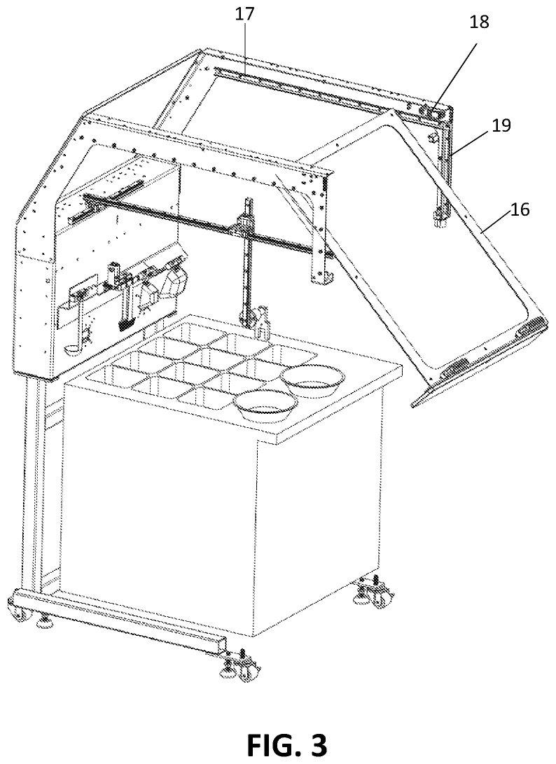

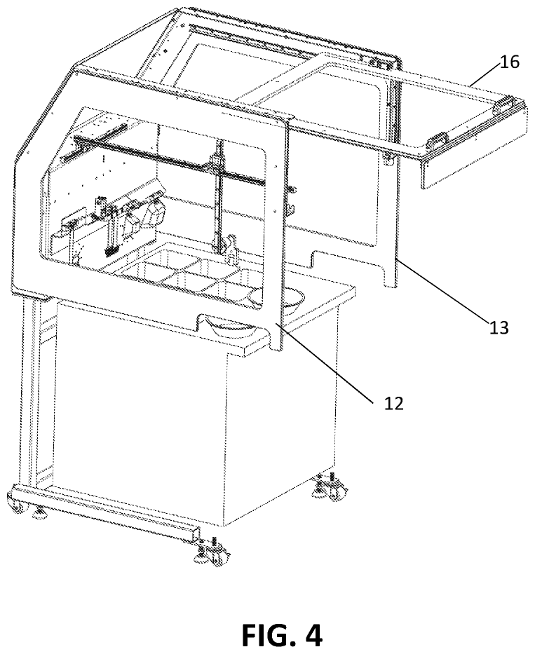

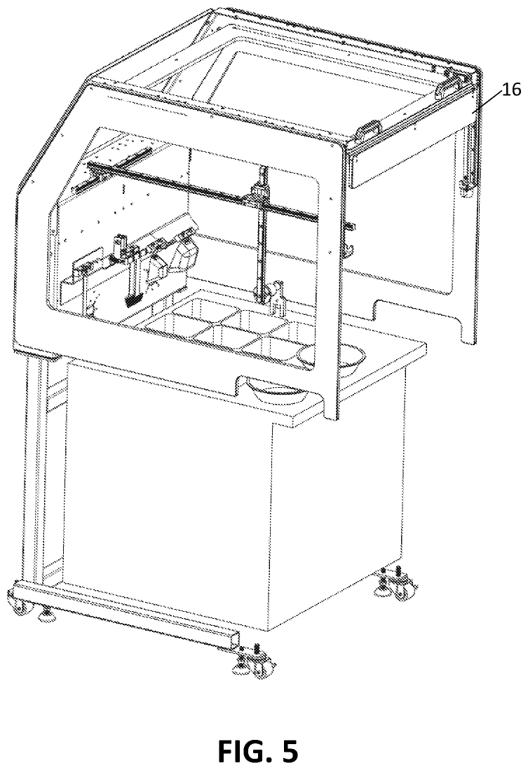

As seen further in FIGS. 2 and 3 with roof 11 removed, horizontal guide 17 and vertical guide 19 are provided for the quick access door rollers to move allowing quick access door 16 to open and move up as soon as door is pulled outwards by an employee preparing to change ingredient containers. An interlock switch 18 is triggered open by this action causing the robot 4 power to be disabled to prevent any injuries to the employee. FIG. 4 show the quick access door in a fully lifted position and FIG. 5 in a safe stowed position.

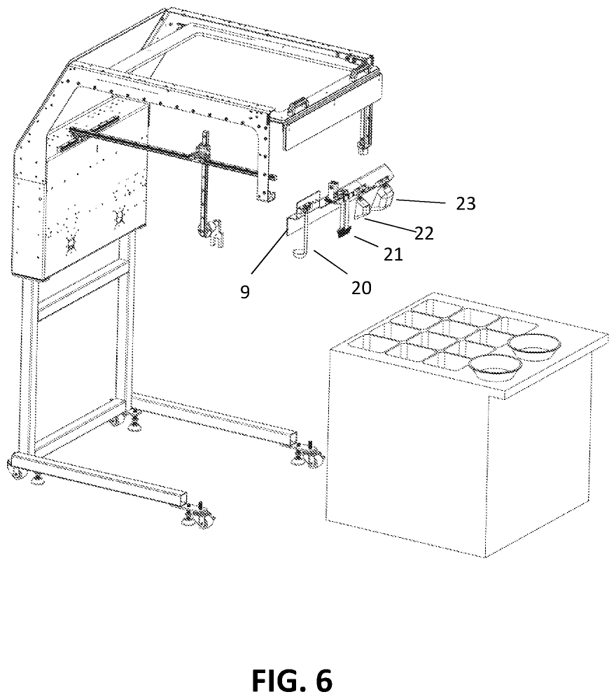

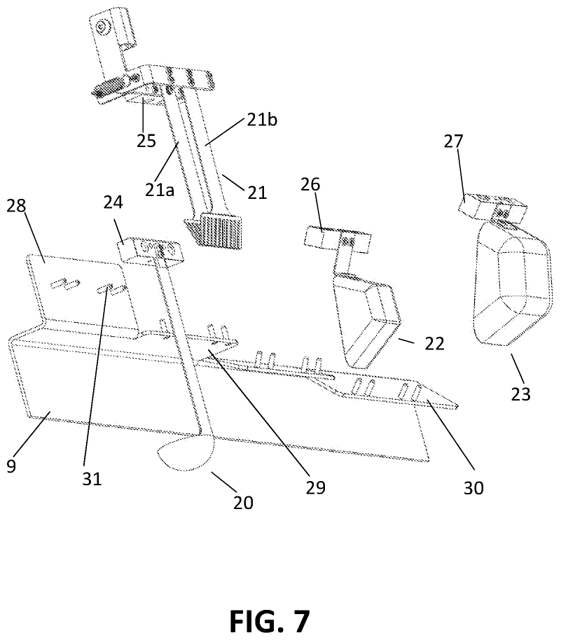

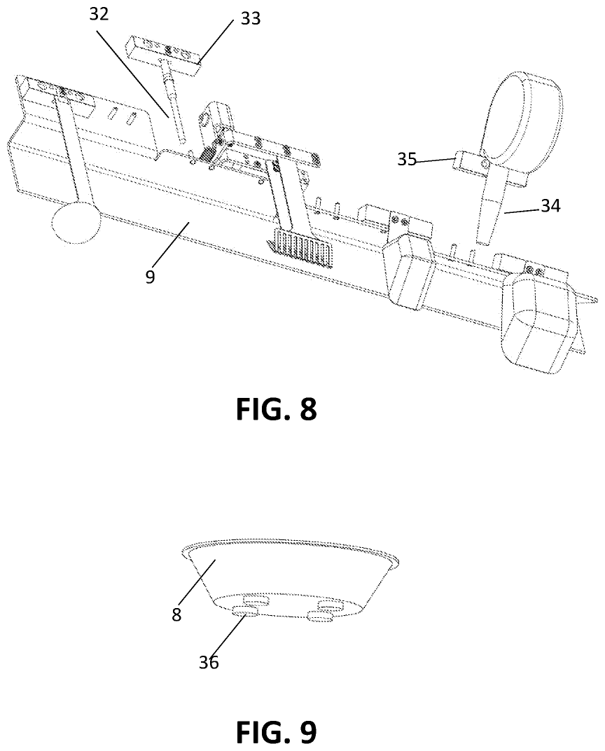

FIG. 6 shows an exploded view of the food assembler device with the attachment tool rack 9 shown removed with a liquid scooper ladle attachment tool 20, a leaf grabber attachment tool 21 with opposing tongs 21a and 21b, a small solids scooper attachment tool 22 and a large scooper attachment tool 23. As can be seen further in FIG. 7 the attachment tools have robot end effector matching interface members 24, 25, 26 and 27 that also have locating features to help them locate on the attachment tool rack locator pins 31 at various storage orientation tabs such as a vertical tab 28, horizontal tab 29 and angled tab 30. FIG. 8 shows a temperature measurement attachment 32 and a vacuum cleaning tool attachment 34 with respective robot end effector matching interfaces 33 and 35.

FIG. 9 shows a detailed view of a order smart boat 8 with a load cell 36. When an ingredient is deposited on to smart boat 8 the load cell can communicate the new weight to the onboard computer 10. On board computer 10 as seen in FIG. 1 is also used for interreacting with user by means of a graphic user interface as is known in the art utilizing touch screen, mouse and keyboard. The onboard computer 10 and robot controller 4 are also connected to a network and capable of accepting orders though software protocols, send back plated order status, ingredient weights to a restaurant computer for billing and record keeping.

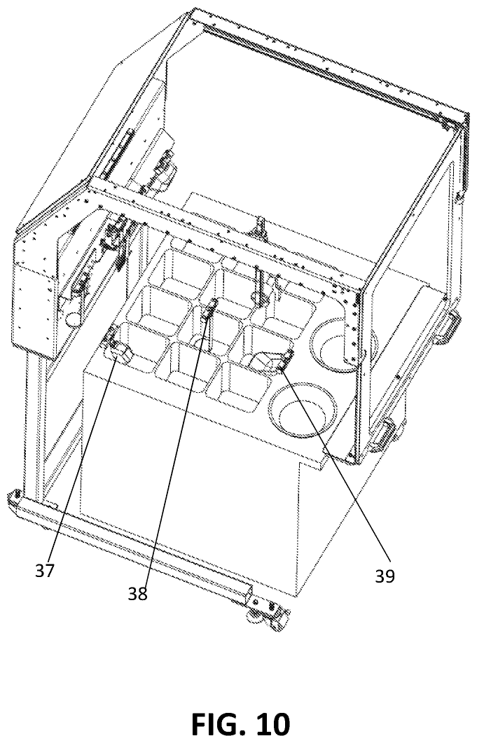

FIG. 10, shows some of the attachment tools 37, 38 and 39 placed in the containers such that the robot 3 is saved of the step to go bring them from rack and put them back when collecting an ingredient from the respective containers for plating them on smart boats.

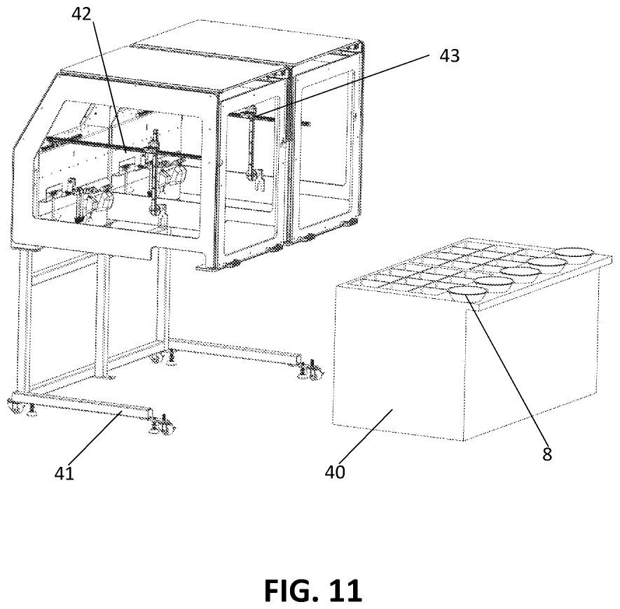

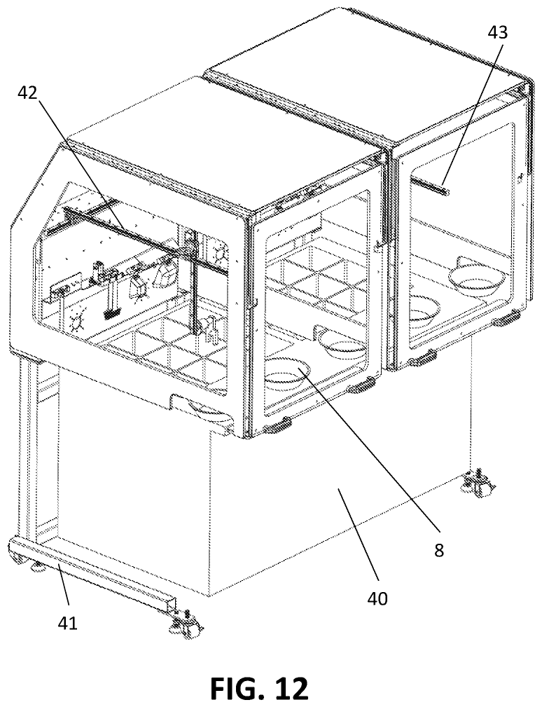

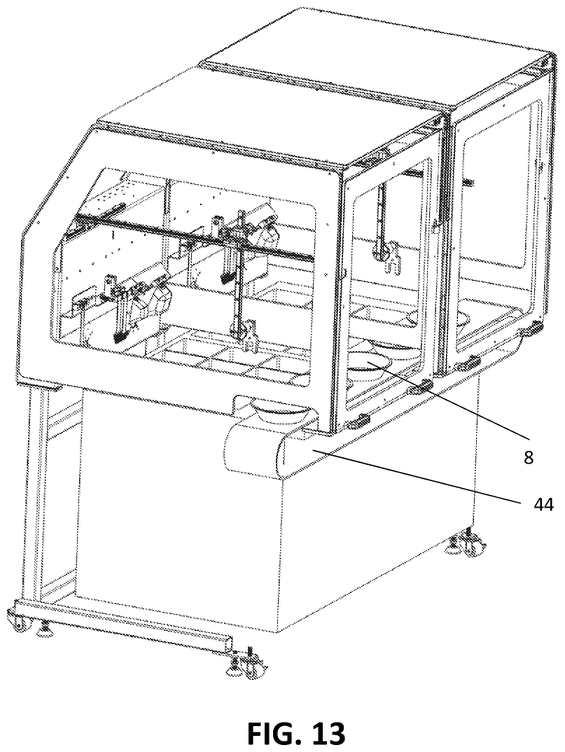

FIGS. 11 and 12 show a dual robot configuration food assembler device 41 with two independent robots 42 and 43 serving together by assembling orders into smart boats 8 from a large sandwich prep table 40. FIG. 13 shows a robot food assembler system with a conveyor belt 44 moving the smart boats across a food assembler device.

All though the invention has been described herein in connection with various preferred embodiments, there is no intention to limit the invention to those embodiments. It should be understood that various changes and modifications to the preferred embodiments will be apparent to those skilled in the art. Such changes and modifications may be made without departing from the spirit and scope of the present invention and without diminishing its attendant advantages. Therefore, the appended claims are intended to cover such changes and modifications.

What is claimed is:

1. A food assembler device comprising:
a plurality of robots;
a plurality of attachment tools;
a plurality of containers placed in an array;
a plurality of boats;
an onboard computer;
wherein, said robot is capable of assembling a customer order with a plurality of ingredients picked from said containers utilizing said attachment tools without said robot coming into direct contact with any of said ingredients.

2. A food assembler device as in claim 1:
wherein said containers are placed in an array in a sandwich prep table.

3. A food assembler device as in claim 1, further comprising:
a quick access door;
an interlock;
wherein opening the door triggers said interlock causing said robot to come to a stop.

4. A food assembler device as in claim 1:
a said attachment tool is scooper;
said robot being able to pick said scooper to scoop ingredients from said containers and deposit them on said boats;

5. A food assembler device as in claim 1:
a said attachment tool is a leaf grabber;
said robot being able to pick said leaf grabber to pick ingredients from said containers and deposit them on said boats;

6. A food assembler device as in claim 2:
a said attachment tool is a vacuum cleaning tool;
said robot being able to pick said vacuum cleaning tool to clean said sandwich prep table as directed by said onboard computer utilizing computer vision.

7. A food assembler device as in claim 2:
where said plurality of said robots work together to serve on said sandwich prep table in their respective areas as directed by said onboard computer;

8. A food assembler device as in claim 1:
a said attachment tool is a temperature measuring device;
said robot being able to pick said temperature measuring device to periodically measure temperature of said ingredients in said containers.

9. A food assembler device as in claim 8:
wherein said onboard computer keeps logs of such temperature measurements.

10. A food assembler device as in claim 1:
where said onboard computer is able to conduct robot sequence optimization when assembling multiple adjacent orders to increase thruput by eliminating multiple attachment tool changes.

11. A food assembler device as in claim 1:
said boats are equipped with load sensors and capable of measuring weights of ingredients deposited on to them by said robot.

12. A food assembler device as in claim 11:
wherein measured ingredient weights are used to calibrate the robot actions of picking and depositing ingredient in desired quantities.

13. A food assembler device as in claim 1:
said robot using said attachment tools is able to reorganize the ingredients in the said containers by moving them around.

14. A food assembler device comprising:
a plurality of robots;
a plurality of attachment tools;
a plurality of containers placed in a sandwich prep table;
a conveyor belt;
a plurality of boats placed on said conveyor belt;
an onboard computer;
wherein, said robot is capable of assembling a customer order with a plurality of ingredients picked from said containers utilizing said attachment tools without said robot coming into direct contact with any said ingredients.

15. A food assembler device as in claim 14, further comprising:
a quick access door;
an interlock;
wherein opening the door triggers said interlock causing said robot to come to a stop.

16. A food assembler device as in claim 14:
a said attachment tool is scooper;
said robot being able to pick said scooper to scoop ingredients from said containers and deposit them on said boats;

17. A food assembler device as in claim 14:
a said attachment tool is a temperature measuring device;
said robot being able to pick said temperature measuring device to periodically measure temperature of said ingredients in said containers;
wherein said onboard computer keeps logs of temperature measurements.

18. A food assembler device as in claim 14:
wherein said onboard computer is able to conduct robot sequence optimization when assembling multiple adjacent orders to increase thruput by eliminating multiple attachment tool changes.

19. A food assembler device as in claim 14:
said boats are equipped with load sensors and capable of measuring weights of ingredients deposited on to them by said robot;
wherein measured ingredient weights are used to calibrate the robot actions of picking and depositing ingredient in desired quantities.

20. A food assembler device as in claim 14:
said robot using said attachment tools is able to reorganize the ingredients in the said containers by moving them around.
